(19) United States
(12) Patent Application Publication
(10) Pub. No.: US 2008/0212106 A1
(43) Pub. Date: Sep. 4, 2008

(54) System and Method for Processing a Profile of a Solid, Which Profile is Captured, Preferably in a Dynamic Manner, to Determine Its Wear

(75) Inventors: Manfred Hoffmann, Kassel (DE); Christian Nowaczyk, Kassel (DE); Michael J. Walter, Voerde (DE); Andreas Brinkmann, Dinslaken (DE); Dieter Hoffmann, Hamminkeln (DE)

Correspondence Address: BRINKS HOFER GILSON & LIONE, P.O. BOX 10395, CHICAGO, IL, 60610, US

(73) Assignee: GUTEHOFFNUNGSHÜTTE RADSATZ GMBH, Oberhausen (DE)

(21) Appl. No.: 11/663,363

(22) PCT Filed: Sep. 19, 2005
(86) PCT No.: PCT/EP05/54668

§ 371 Date: Mar. 20, 2007

(30) Foreign Application Priority Data
Sep. 20, 2004 (DE) 10 2004 045 850.2

(51) Int. Cl. G01B 11/24; G01B 11/02

(52) U.S. Cl. 356/606; 356/635

(57) ABSTRACT

A method for the processing of a profile of a solid which has been detected, dynamically, for the purpose of determining wear which has occurred. The data from the evaluated profile are used as a control variable for controlling at least one machine for surface machining on the solid.

### CROSS REFERENCE TO RELATED APPLICATIONS

This application claims priority to German Patent Application 10 2004 045 850.2, filed Sep. 20, 2004 and PCT/EP2005/054668, filed Sep. 19, 2005.

### FIELD OF THE INVENTION

This invention relates to a system and method for the further processing of a profile of a solid workpiece which has been detected, preferably dynamically, particularly for the purpose of determining wear which has occurred.

### BACKGROUND AND SUMMARY OF THE INVENTION

The German patent application DE 103 13 191.4 and the international patent application PCT/EP 04/00295 describe a contactless method for the dynamic detection of the profile of a solid object, particularly for the purpose of determining wear which has occurred on the solid, where provision is made, in order to allow short measurement times to be observed, a measurement range covering at least three orders of magnitude, such as tenths of millimeters, millimeters and centimeters, and a high level of measurement accuracy even under severe operating-conditions. In one type of measurement system, at least one beam of light, which is generated by a laser device and expanded to form at least one linear band of light is projected onto at least one region of the surface of the solid, with the solid moving past the laser device and the light reflected from the region of the surface of the solid being focused on a sensor device, whose optical axis is at a fixed triangulation angle relative to the direction of projection of the laser device and which is arranged at a fixed basic distance from the laser device. A two-dimensional light sensor element at a high frequency is used in comparison with a speed of movement of the solid, after which the measured values for the profile are obtained from signals output by the light sensor element on the basis of the triangulation angle and the basic distance in a data processing device using trigonometric relationships. The system further uses a logic system with correction values determined on the basis of the speed of movement of the solid. The measured values being stored as a profilogram in the data processing installation.

In this case of the above described system, the solid may be a rotationally symmetrical body making a translational, rotating or preferably rolling movement, for example is a vehicle wheel. The inventive method is therefore an extremely advantageous way of determining profiles for a wheel during motion and of drawing conclusions about wear therefrom.

For full profile detection, provision may be made for a plurality of profilograms to be determined as component profilograms using at least three regions, situated on different sides of the surface of the solid laser devices projecting bands of light and sensor devices associated therewith are used. The component profilograms are stored in the data processing installation and for an overall profilogram to be obtained therefrom. In the case of a solid whose basic shape is essentially cylindrical or annular, such as a vehicle wheel, at least three regions onto which the bands of light are projected may preferably be situated on the two top faces and on the outer face of the cylinder or ring. The profilogram, the component profilograms and/or the overall profilogram can then respectively be compared with one or more reference profilograms, and the respective discrepancies from the respective reference profilogram can be established, which is a measure of the wear which has occurred or a measure of whether the wear which has occurred is still within a tolerable range. In this connection, correlative links between the stress time which has arisen for the solid and the established wear can also be used to make an extrapolating projection about how long further stress time still appears feasible or when another examination appears necessary.

In this context, it has been found to be advantageous if the profilogram, the component profilograms, the overall profilogram, the respective reference profilogram and/or the respective discrepancies are related to a fixed geometrical basic size which does not alter over a long time, such as a wear-free wheel rim inner circumference. In this way, the wear face can be shown as a development, for example, on which the depth profile relative to the basic size is depicted by suitable means of representation. By way of example, the profilogram, the component profilograms, the overall profilogram, the respective reference profilogram and/or the respective discrepancies can be visually displayed on a display apparatus, such as a visual display.

The aforementioned patent applications also describe a wear test stand for wheels on a rail vehicle, such as railway wheels, in which the method described is used. The wear test stand is designed for wheels which roll on rails and move at a translational speed and an angular speed as the solid which is to be surveyed. In this case, particularly a reference radius for the rolling wheel is ascertained as the basic size from the dynamically determined measured values using an equation system. The ascertained radius may firstly be used as a basic line for measured values for the profile depth which are ascertained on the outer face of the wheel, and secondly it is possible to use this radius to determine correction values which need to be taken into account in line with the laser triangulation method on which the measurement is based.

As far as the further processing of the dynamically detected profile is concerned, it is stated that the respective profilogram, the component profilograms and/or the overall profilogram can respectively be compared with one or more reference profilogram(s), and the respective discrepancies from the respective reference profilogram can be established. The reference profilograms may preferably be admissible specified sizes, but a reference profilogram can also be a stored data record for measured values from an earlier measurement, so that the respective discrepancies provide an indication of how great is the wear which has occurred since the past measurement is.

The present invention is based on the object of providing a system and method for the further processing of a profile shape of a solid which has been detected, preferably dynamically, particularly for the purpose of determining wear which has occurred which goes beyond the known processing of measured value signals for a solid profile, particularly for establishing the wear and for comparison with a reference profile.

The invention achieves these objects by means of a method of the type mentioned in which data from the detected profile of the solid are used as a control variable for controlling at least one machine for surface machining, particularly for mechanical surface machining on a rail vehicle wheel.

The invention also achieves these objects by means of a system of the type mentioned which has system components whose interaction implements the control of at least one machine for surface machining, particularly for mechanical surface machining on a rail vehicle wheel, using the data from the detected profile of the solid.

In this context, further parameters, such as geometric data, technological data, tool data and/or work schedules, may be used for the data conditioning for machine control. The control of transmission to the machine can then be effected using a suitable hardware interface, such as electrical interfaces, e.g. RS232, RS422, TTY. The supply of material can also be controlled in this way.

In this case, the surface machining can be carried out particularly for repair purposes—in the sense of what is known as reprofiling—particularly on a worn solid with which the detected solid profile can be associated. Alternatively, it is possible to provide control variables for producing a new solid, for example when rail vehicle wheels which can no longer be reprofiled are replaced completely and may be matched to an existing wheel set which can still be reprofiled, from a plurality of solid profiles as a generalization for respective determined geometries, technologies, e.g. a particular use of materials and/or an initially set surface quality and for the tool data, e.g. by means of averaging and/or interpolation or extrapolation based on a further running time or a desirable total running period.

If, as presented at the outset, the further processing of the data from a profile comprises comparison of the respective profilogram with a reference profilogram, and the respective discrepancies from the respective reference profilogram are established, this means that the repair, or possibly even the production, can be matched to the actual wear in optimum fashion. This results in advantages for the technology and the use of materials in the sense of opening up a savings potential. Thus, by way of example, wheels which do not require repair and for which the profilograms, following comparison with what is known as a learning curve, particularly one recorded on a wear test stand, not just a prescribed limit value for the wear but also a prescribed warning value corresponding to a lower level of wear is not reached, can be excluded from repair from the outset.

Further advantageous embodiments of the invention can be found in the detailed description below.

### BRIEF DESCRIPTION OF THE DRAWINGS

An exemplary embodiment illustrated by the accompanying drawing is used to explain the invention in more detail. In the drawing,

FIG. 1 shows a block diagram to illustrate the inventive method and system,

FIG. 2 shows visual displays, shown on a display, of profilograms as may be used in a method and system based on the invention,

FIG. 3 shows a schematic perspective view of a basic illustration showing the principles of the preferred method which is used to detect the profile of a solid as processed in accordance with the inventive method,

FIG. 4 shows a program flowchart for the detection of the profile of a solid in conjunction with the inventive method, and

FIG. 5 shows a perspective view of a wear test stand for wheels on a rail vehicle, such as railway wheels, for which the inventive method is preferably used.

### DETAILED DESCRIPTION OF THE PREFERRED EMBODIMENT

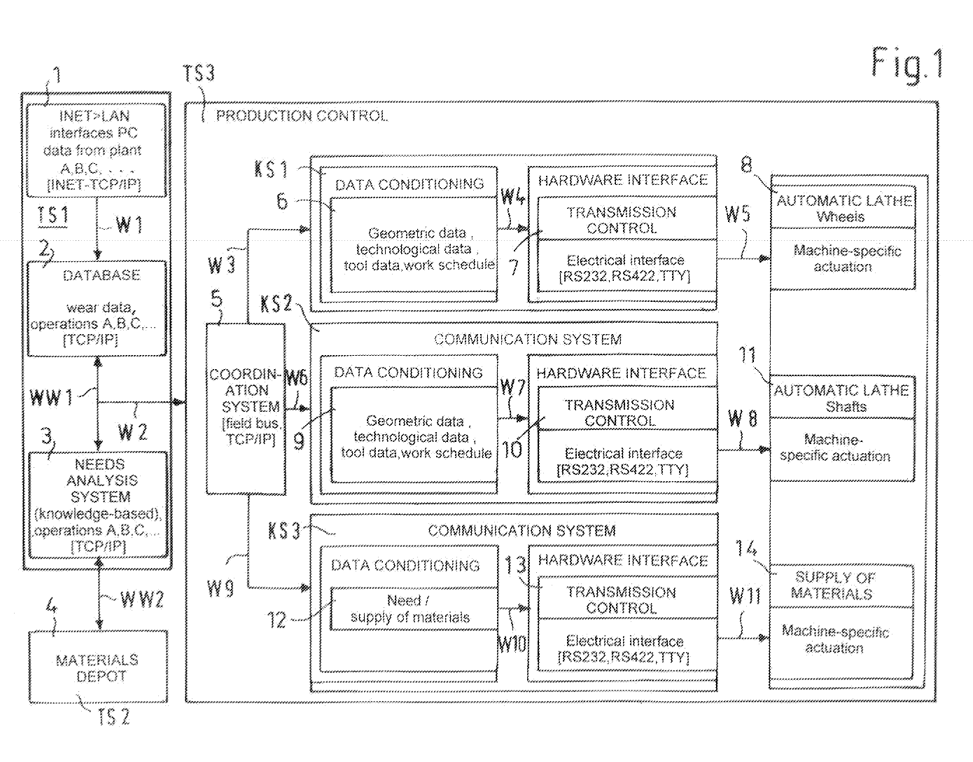

As FIG. 1 illustrates, a system based on the invention is formed from a plurality of system components whose characteristics and mode of action are indicated in the blocks shown and are symbolized by the arrows shown. In this case, the reference symbols 1 to 14 denote the individual system elements which are present in the case shown, and the reference symbols W1 to W11 denote system couplings on the action arrows between the system components, with the reference symbols WW1 and WW2 identifying special system couplings which act in the sense of an interaction. The reference symbols TS1 to TS3 denote subsystems in the inventive system, and the reference symbols KS1 to KS3 denote communication systems, which are in turn subsystems in the subsystem TS3 used for production control.

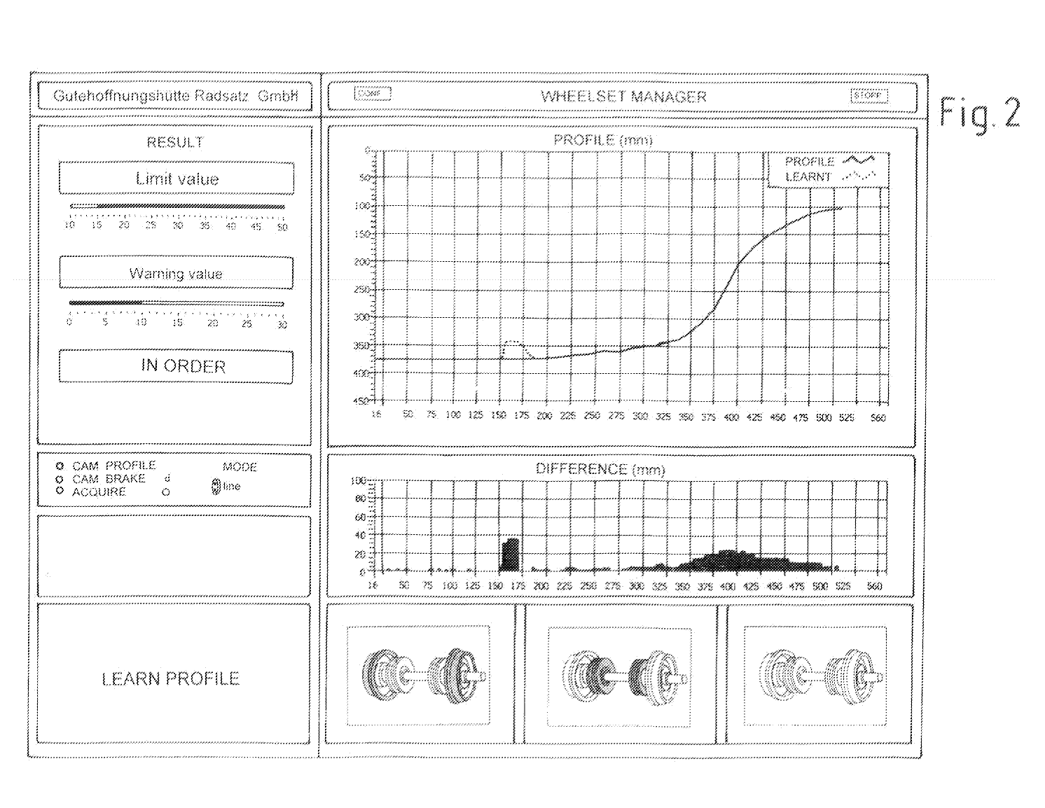

Besides the three communication systems KS1 to KS3 which are present, the subsystem TS3 used for production control comprises a coordination system 5 and processing machines, particularly automatic lathes 8, 11, for surface machining, particularly for mechanical surface machining on a rail vehicle wheel, this machining being carried out using data from a detected profile of the solid, as shown in FIG. 2, for example.

The communication systems KS1 to KS3 respectively comprise a system element for data conditioning 6, 9, 12 and a hardware interface 7, 10, 13 for transmission control to the machines (automatic lathes 8, 11) or for supplying material 14. In this case, actuation is always effected on a machine-specific basis, e.g. as indicated, via electrical interfaces RS232, RS422 and TTY. Thus, feed and delivery speeds, for example, can be controlled for a material depth to be removed which needs to be attained as the result.

In the system elements for data conditioning 6, 9, further parameters, such as geometric data, technological data, tool data and/or work schedules, besides the data from the detected profile of the solid as a control variable, which are preferably compared with a reference profile—as shown by the graphics component “DIFFERENCE” in FIG. 2, for example—to determine wear, are used to control at least one machine, namely the automatic lathe 8, for surface machining.

A system element for data conditioning 12 can also be used—as illustrated—to determine material requirement and supply.

In addition, it is also possible for the inventive system to comprise not only the function of a machine for mechanical surface machining, such as that of the automatic lathe 8, for machining particularly the running surface of the wheels, but also the functions of several processing machines, such as those of an automatic lathe 11 for mechanical machining of shafts.

The individual communication systems KS1 to KS3, in which the flow of the technical information in the form of signals predominantly from a respective input to a respective output occurs predominantly linearly (W3, W4, W5 in KS1, W6, W7, W8 in KS2, W9, W10, W11 in KS3), may be preceded by a coordination system 5 in which the information signals are reciprocally coordinated and which in this way forms the subsystem for production control TS3 together with the communication systems KS1 to KS3.

As illustrated, an input variable (system coupling W2) for the subsystem for production control TS3 may originate, by way of example, from at least one further subsystem TS1 or from an interaction WW1 between two further subsystems, such as subsystems TS1 and TS2 (materials depot 4).

In the case illustrated, said subsystem TS1 comprises three fundamental system elements 1, 2, 3.

The first system element 1 is an interface which, by way of example, implements an Internet (INET) or local area network (LAN) link via a personal computer (PC), with a conventional TCP/IP protocol advantageously being able to be used for data transfer, e.g. for transmitting data detected at several different locations (plants A, B, C, . . . ) from profiles of solids, particularly wheel profiles.

The second system element 2 contains a database which stores the data detected at the different locations (plants A, B, C, . . . ) from profiles of solids, particularly wheel profiles, in the form of wear data (see, as mentioned, graphics component “difference” in FIG. 2), km coverages, nominal and/or learning curves.

The second system element 2 can interchange information (interaction coupling WW1) with the third system element 3, which is a needs analysis system which for its part can interact WW2 with the materials depot TS2, 4. The needs analysis can be performed in the third system element 3 on the basis of knowledge-based databases which are implemented in the system element 3. These may be databases obtained empirically by means of extrapolation or interpolation of measured values for wear, or may be databases which are based on a particular wear model which has been set up according to theory, with hybrid forms also being possible. The needs analysis can be used to control deliveries of material to the depot 4, for example such that the materials depot 4 always has material available within the context of “Just In Time” production or else preferably—within the context of stable production conditions—original material for a predetermined period of time, e.g. three to four weeks.

Besides the aforementioned graphics component “difference”, which uses a bar graph of profile depth over measured length to show the wear data used in line with the invention, preferably as a control variable for the automatic lathe 8 in FIG. 1, FIG. 2 also contains the data from the originally detected profile (PROFILE) as a comparison with a nominal curve (LEARNT) in the graphics component “profile”. In this case, the type of representation corresponds to the graphics component “difference”, with a profile line being shown instead of the bar graph. The representation in FIG. 2 may be a display which is integrated in a subsystem TS1, TS2, TS3 in an inventive system and which also displays measurement and/or machining locations in the form of graphical representations (bottom). The display may also contain verbal information, like the result combinations (RESULT) shown in the left of the figure, which can be used to indicate, by way of example, whether the measured profile exceeds a limit value or a warning value or is in order, which means that it does not need to be reprofiled.

The subsystems TS1, TS2, TS3 may—within the context of optimized location distribution—be at physically separate locations. In particular, the data from the profile (PROFILE) may be detected in a client from a client/server arrangement where the server is physically remote from the client.

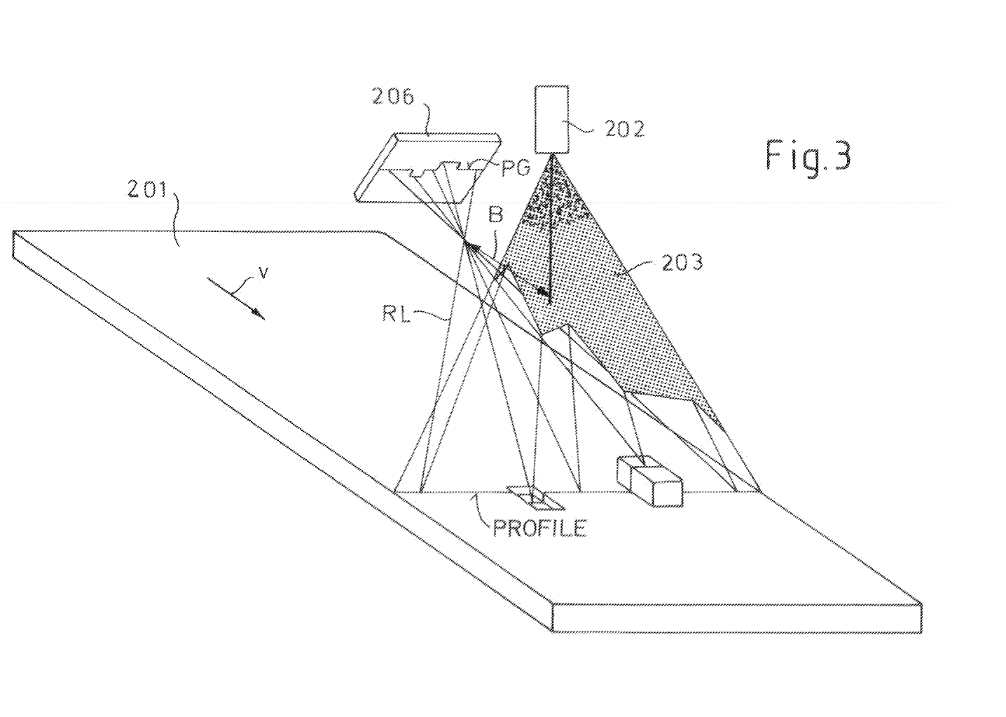

FIG. 3 will be used to explain the principles of the preferred method which can be used to detect data from the profile (PROFILE) of a solid which have been processed using the inventive method. This explanation is significant to the extent that particularly the nature of the data from the profile (PROFILE) is obtained from the principle of detecting the data.

To pick up the topography of a three-dimensional solid 201, which is preferably moving at a speed v, i.e. to obtain data from the profile (PROFILE) which are to be processed in line with the invention, a laser beam which is output from a laser device 202 and widened to form a band of light 203 is used, as shown in FIG. 3. The band of light 203 is returned by the surface of the solid 201 as reflected light RL and is detected by a two-dimensional recording element 206, such as a CCD camera, as a light sensor element in the form of a profilogram image PG. The measured values from the profile (PROFILE) are then determined from signals which are output by the recording element 206—in line with the essence of the inherently known laser triangulation method used—taking account of a triangulation angle and a basic distance B between the optical axis of the reflected light RL and the laser device 2—in a data processing device (not shown), such as a PC, and are stored as a profilogram. To represent such a profilogram, the schematic illustration in FIG. 3 shows the route of the profilogram image PG on the light sensor element 206.

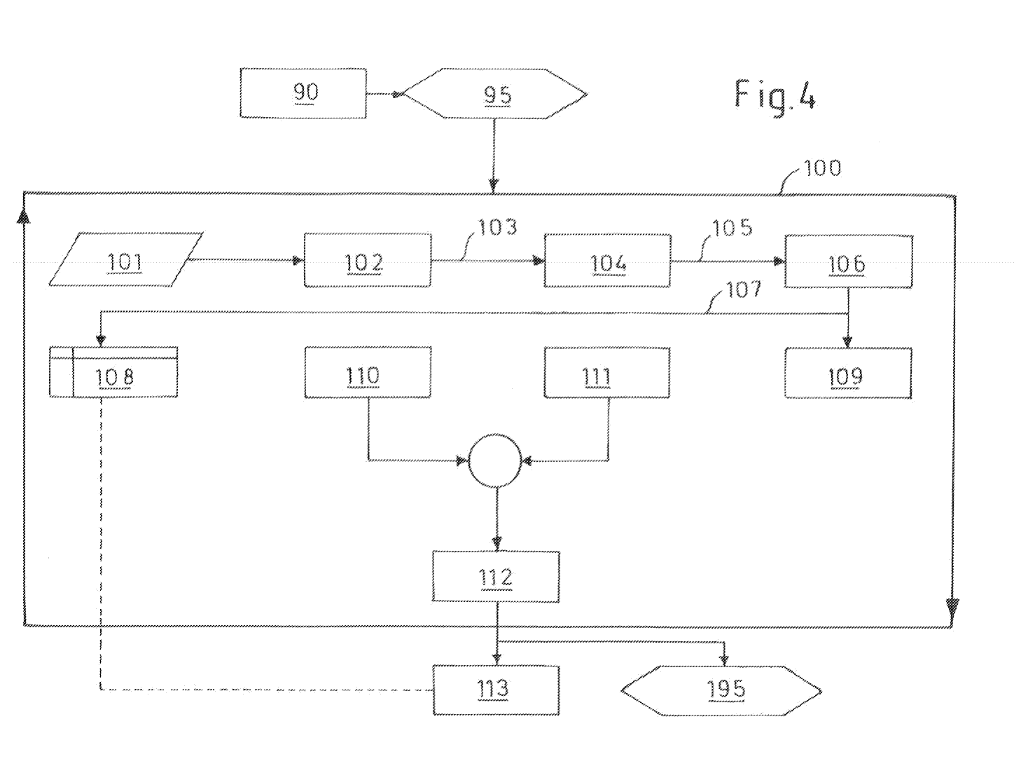

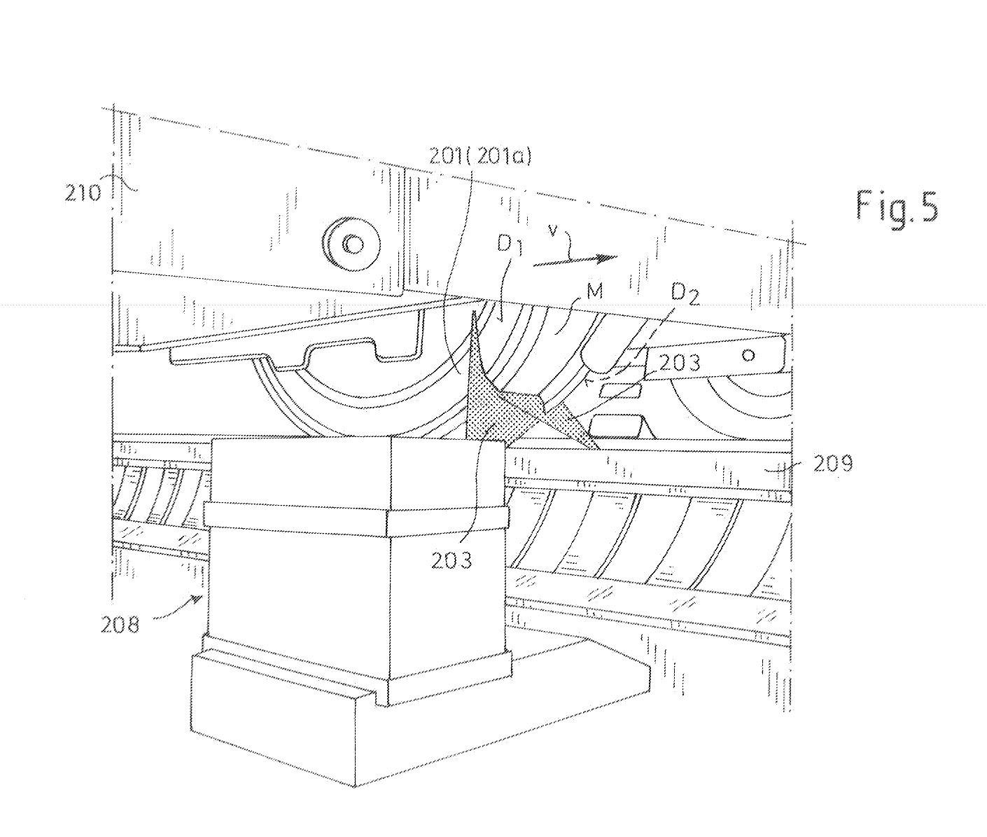

The program flowchart shown in FIG. 4 is tailored particularly to the contactless detection of the profile (PROFILE) of wheels on a rail vehicle, such as railway wheels, using the laser triangulation method shown in FIG. 3. Such a wheel is shown by way of example—with the reference symbol 201a—on a rail vehicle 210 in FIG. 5.

The program flowchart comprises, in particular, a recording loop 100 for dynamically detecting the profile (PROFILE) of the solid 201 or 201a, said recording loop being set in motion using system start processes which are initiated by a request 90 from a server which is preferably in the subsystem TS1 shown in FIG. 1 as system element 1. These system start processes are symbolized in FIG. 4 by the box identified by the reference symbol 95 and may comprise actuation of a set of traffic lights for the rail vehicle 210, activation of a trigger for image triggering in the recording element 206 and turning on the laser device 202.

In this case, a laser distance sensor 101, which is the light sensor element 206, in particular, provides a distance signal 103, in particular, in the recording loop 100 after signal conditioning 102, i.e. starting conditions for the solid 201, 201a, such as the distance from the laser device 202, a light intensity distribution and, if appropriate, an alteration in this distance over time, are ascertained at a starting time to as a first and—when movement is accelerated—also a second derivation of the travel on the basis of time.

In the “signal evaluation” method step 104, the starting conditions—particularly the distance signal 103—are then used to determine a detection time t_{flash} for which signals which are output from the recording element 206 are selected in order to obtain the measured values for the profile (PROFILE). In detail, this means that a trigger impulse 105 is output to the recording element 206, e.g. to a camera, which prompts image triggering 106 at the detection time t_{flash}. The detection time t_{flash} determined from the starting conditions should in this case be ascertained using the criterion of greatest possible proximity in time to the starting time t₀, since for this case the signals which are present at the starting time t₀ and at the detection time t_{flash} differ only a little, which is advantageous for the signal evaluation.

In this case, the detection time t_{flash} can be determined from the starting conditions (distance signal 103) particularly using a digital signal processor (DSP) which may preferably be integrated into an existing data processing device. This sometimes necessitates the connection of an analog/digital converter upstream of the DSP if the laser distance sensor 101 does not deliver a digital signal.

On account of its very accurate predictability and extremely short time required for executing the desired operations, a digital signal processor (DSP) is just right particularly for real-time, i.e. continuous, processing of the signals. Its use for the signal evaluation 104 advantageously allows optimum processing of the data available in the form of digital signals both in respect of data manipulation, such as data movement, storage and/or value checking, and in respect of mathematical calculations, such as addition and multiplication operations. Thus, as far as the mathematical calculations are concerned, the signal evaluation 104 can perform filtering operations, convolution operations and Fourier, Laplace and/or z transformations in the millisecond range. As far as data manipulation is concerned, a DSP can thus be used for highly efficient data compression before data storage or before remote data transmission—similarly in the millisecond range.

The use of a DSP also allows the change in the distance between the solid 201, 201a and the laser device 202 over time, i.e. for example the speed of individual subregions of the solid 201, 201a which are particularly relevant for dynamic profile detection and which can preferably be used for determining the detection time t_{flash}, to be ascertained from the starting conditions if this speed is not detected or firmly prescribed or set to be associated with the starting conditions through direct determination.

Within the context of rapid signal processing—and hence proximity of timing between the starting time t₀ and the detection time t_{flash}—it is beneficial if the starting conditions for the solid 201, 201a at the starting time to are ascertained by using the signals which are output by the recording element 206 to obtain a pattern, particularly a binary-encoded mask, and stipulating the detection time t_{flash} preferably using the criterion of presence, i.e. recognition, of this pattern.

To obtain and recognize the pattern, a light intensity distribution, particularly in the form of a transparency distribution, which is present on the solid 201, 201a at the starting time t₀ and/or at the detection time t_{flash} may in this case advantageously be detected in a histogram and, preferably using a lookup table (LUT), be subjected to image transformation, particularly to a threshold value operation, such as high-pass filtering, preferably performed using Laplace transformation. In this context, a lookup table (LUT) is understood—as is customary in image processing—to mean an associatively connected structure of index numbers for a field containing output values. An example of a known LUT is what is known as the color map or pallet. This has an associated limited number of color indices—usually 256 color and intensity values. Within the context of the invention, in particular detected and/or subsequently transformed lookup tables can be dynamically matched to the starting conditions at the relevant time t₀. Such signal processing therefore does optimum justice to randomly changing or regularly existing environmental conditions, such as the change in lighting conditions as a result of indoor light, the position of the sun or seasonal influences, such as snow when detecting outdoors.

The pattern, particularly the binary-encoded mask, can be obtained and recognized particularly using an alpha channel, preferably a binary alpha channel. In this context, alpha channel (α channel) is to be understood to mean a channel which is provided in addition to the three color channels usually used—in digital images when taking images and processing—and which also stores the transparency of the individual pixels in addition to the color information encoded in a color space. By way of example, this can be done by providing one byte per pixel, which results—as mentioned—in 2⁸=256 possible gradations for the light intensity. A binary alpha channel is a minimalized alpha channel which involves the use of just one bit for encoding the transparency and therefore can only indicate whether a pixel is either fully transparent (black) or fully opaque (white).

In the case of and besides, or in addition or as an alternative to, the practice described by way of example above, a recognition pattern can also be extracted and recognized using other instances of the methods usually subsumed under the name “intelligent image processing”, particularly filter operations, such as what is known as focusing an image or producing a chrome effect.

If the image triggering 106 takes place at the detection time t_{flash} then particularly an image matrix 107—preferably in the form of a first full image after the trigger impulse 105—is detected and the detected image is supplied to a storage section 108. At the same time, a timer is reset 109. The processes described are executed repeatedly, as illustrated by the recording loop 100.

The abortion criteria used for the processes in the recording loop 100 are the condition checks illustrated by the boxes denoted by the reference symbols 110 and 111. In this case, it is firstly checked (box 110) whether the timer is already exceeding 10 s and secondly whether all the axles of the rail vehicle 210 have been recorded (box 111). If one of these conditions applies then the image recording is stopped (box 112). The question of whether the timer is already exceeding 10 s is aimed at establishing whether the solid 201 or 201a may have come to a standstill. When the image recording has been stopped 112, the stored image data 108 can be sent to the server (box 113). At the same time, the system stop processes “turn off trigger”, “turn off laser device 202” and “actuate traffic lights for the rail vehicle 210” may take place, which is symbolized by the box identified by the reference symbol 195.

FIG. 5 shows a typical application of the inventive method, specifically for determining wear. The illustration shows a perspective view of a wear test stand 208 which is designed for wheels 201a which roll on rails 209 and move past at a speed v, as the solid 201 to be surveyed. To implement the processes illustrated in the program cycle in FIG. 4, particularly the recording loop 100, the relevant hardware can be incorporated into the test stand 208, which advantageously means—as already mentioned—that a client/server arrangement can be produced in which the client is situated on the platform 209 and the server is situated at a physically remote location.

The wheel 201a of the rail vehicle 210 is a rotationally symmetrical solid 1 whose basic shape is essentially cylindrical or annular, with the case illustrated being provided with two regions onto which bands of light 203 are projected. The regions are located on the two top faces D₁, D₂ and on the outer face M of the cylinder or the ring. The advantage of using two bands of light 3a, 3b in this case is as follows: as a result of the starting conditions 103 for the solid 201, 201a being ascertained at a starting time t₀ and then the detection time t_{flash} being determined from the starting conditions 103, for which detection time the signals which are output from the recording element 206 are selected, it is possible to project the bands of light 203—simultaneously or else at different times—onto one and the same measurement location for a position on the outer face M. This in turn allows regions of the various sides D₁, D₂, M of the surface of the solid 1 which are not detected by a band of light 203 on account of shadowing, as a result of shadowing owing to preferably lateral radiation of the bands of light 203, to be accessible through the respective other band of light 203 with appropriate positioning of the generating laser devices 202 relative to one another for detection. The component profilograms ascertained in this manner may be stored in the data processing device, and an overall profilogram may be obtained therefrom through superimposition.

The inventive method advantageously allows the detection and processing of a profile (PROFILE) in an extraordinarily short determination time. Thus, the laser devices 202 and depiction devices 5 arranged on both sides of the rails 209 on which the rail vehicle 210 is rolling past can be used to create a respective three-dimensional profilogram, for example for five bogies, i.e. ten wheel sets, in real-time operation which is immediately available for further processing. For such a profilogram, a resolution of less than 2.0 mm, particularly a resolution of less than 0.2 mm, can be achieved in this case.

An advantage in terms of equipment is that the invention also has the associated possibility of considerable reduction of the apparatus involvement in comparison with known methods, because with a translational speed of movement for the solid 201 of less than 3.5 m/s it is not necessary to use a high speed camera, or else when a high speed camera is used it is possible to take measurements when the solid is moving at very high translational speeds. It is therefore possible to carry out profile determination on rail vehicle wheels 201a on an ICE traveling past the test stand 208 at maximum speed, in which case the detected profile (PROFILE) is available as a control variable on a machine 8 for surface machining in a very short time—for example after the train has entered a machining building.

The present invention is not limited to the illustrated exemplary embodiment, but rather covers all means and measures which have the same effect within the context of the invention. Thus, by way of example, wear does not have to be determined using the “LEARNT” curve shown in FIG. 2, but rather the comparison curve can—if available and possible in the association—also be represented by an earlier measurement on the same object. The type of detection of the profile (PROFILE) which is shown in FIGS. 3 to 5 is a preferred manner of obtaining data which is synergistic in terms of the efficiency and accuracy of the method in its interaction with the inventive further processing of the profile (PROFILE) but which does not limit the further processing based on the invention.

With reference to FIG. 5, which reveals the approximate ratios of sizes for the aforementioned test stand 208 and a rail vehicle wheel 201a, it can be stated that a test stand 208 which is designed for use of the inventive method may have a very much smaller and more compact physical size than the one shown—for example approximately twice the size of a shoe box. It is therefore advantageously possible in most cases to dispense with complex concrete work when implementing the test stand 208 into a track.

While the above description constitutes the preferred embodiment of the present invention, it will be appreciated that the invention is susceptible to modification, variation and change without departing from the proper scope and fair meaning of the accompanying claims.

1. A method for the processing of a profile of wheel of the type for running on a rail which has been detected, dynamically, for the purpose of determining wear which has occurred on the wheel, wherein that data from the evaluated profile of the wheel are used as a control variable for controlling at least one machine for surface machining of a surface of the wheel.

2. The method as claimed in claim 1, wherein the data from the detected profile are used as a control variable for controlling feed and delivery speeds for setting a material depth which is to be removed from the surface of the wheel by the at least one machine.

3. The method as claimed in claim 1 wherein the data from further parameters, including one or more of geometric data from the wheel, technological data, tool data and work schedules, are used as control variables for controlling the at least one machine for the surface machining.

4. The method as claimed in claim 1 wherein the data from the detected profile or the data from the further parameters are used for controlling the supply of material from a materials depot to the machine for the surface machining.

5. The method as claimed in claim 1 wherein the data from the detected profile are used for needs analysis which is carried out using a knowledge-based needs analysis system and which is taken as a basis for controlling deliveries to the materials depot.

6. The method as claimed in claim 1 wherein the surface machining is carried out for repair purposes as reprofiling of the wheel with which the detected profile is associated.

7. The method as claimed in claim 1 wherein the application of the control variables for producing a new wheel for completely replacing a rail vehicle wheel which can no longer be reprofiled.

8. The method as claimed in claim 7 wherein the control variables for producing a new wheel are provided from the profiles of a plurality of the wheels as a generalization for respective determined geometries for the new wheel.

9. The method as claimed in claim 1 wherein the control variables are obtained from the profiles of a plurality of the wheels by means of averaging, or interpolation or by means of extrapolation based on a further running time or a desirable total running period for the wheel.

10. The method as claimed in claim 1 wherein a plurality of the control variables are provided for a respective determined use of materials or for a predetermined surface quality of the wheel.

11. The method as claimed in claim 1 wherein the data from the profile are detected at a plurality of different sites.

12. The method as claimed in claim 1 wherein the data from the profile are detected in a client from a client/server arrangement where the server is physically remote from the client.

13. The method as claimed in claim 12 wherein the system start processes on the client, such as actuation of traffic lights for a rail vehicle, activation of a trigger for image triggering in a CCD camera, turning on a laser device used for obtaining the data from the profile or starting a recording loop for obtaining the data from the profile, are set in motion by means of a request from the server.

14. The method as claimed in claim 12 wherein a detection time (t_{flash}), for which signals output by the camera are selected for the purpose of obtaining the data from the profile, is determined in a recording loop which is implemented by incorporating a hardware component into a test stand situated on a platform for rail vehicles.

15. The method as claimed in claim 1 wherein the data from the profile are detected, particularly in the recording loop, by virtue of a laser distance sensor providing, at a starting time (t₀), a signal for starting conditions for the wheel, at a distance from the laser device, and detection on alteration in the distance over time or a light intensity distribution.

16. The method as claimed in claim 15 wherein the detection time (t_{flash}) for obtaining the data from the profile, at which a trigger impulse is output to a recording element, is determined from the signal for the starting conditions for the wheel by a signal evaluation section, as a result of which image triggering is effected, with an image matrix being detected and the detected image being supplied to a storage section.

17. The method as claimed in claim 16 wherein a digital signal processor (DSP) is used to determine the detection time (t_{flash}) for which signals output by the recording element are selected for obtaining the data from the profile.

18. The method as claimed in claim 16 wherein the detection time (t_{flash}) determined from the starting conditions is ascertained using the criterion of greatest possible proximity in time to the starting time (t₀).

19. The method as claimed in claim 16 wherein the starting conditions for the wheel at the starting time (t₀) are ascertained by using the signals which are output by the recording element to obtain a pattern, particularly a binary-encoded mask, and stipulating the detection time preferably using the criterion of presence, of this pattern.

20. The method as claimed in claim 19 wherein the pattern is obtained and recognized by detecting a light intensity distribution, particularly in the form of a transparency distribution, which is present on the wheel at the starting time (t₀) or at the detection time (t_{flash}) in a histogram and, using a lookup table (LUT), subjecting it to image transformation, including a threshold value operation.

21. The method as claimed in claim 19 wherein an alpha channel is used to obtain and recognize the pattern, including the binary-encoded mask.

22. The method as claimed in claim 19 wherein the pattern is obtained and recognized using methods of intelligent image processing.

23. The method as claimed in claim 12 wherein condition checks attached to a timer or to a number of predetermined measurements in the client, in the recording loop, are carried out as abortion criteria for obtaining the data from the profile.

24. The method as claimed in claim 12 wherein when the data from the profile have been obtained, when the image recording has been stopped, the data from the profile, particularly stored image data, are sent from the client to the server.

25. A system for the further processing of a profile of a wheel of the type for running on a rail which has been detected dynamically, for the purpose of determining wear of the wheel which has occurred, characterized by system components which, by virtue of their couplings and interactions, implement the control of at least one machine for surface machining of a surface of the wheel using the data from the detected profile of the wheel.

26. The system as claimed in claim 25, wherein the system components which, by virtue of their couplings and interactions, implement the control of further machines for the surface machining, including an automatic lathe for mechanical surface machining of the wheel, using the data from the detected profile of the wheel.

27. The system as claimed in claim 25 wherein the system components which, by virtue of their couplings and interactions, implement machine-specific actuation of a supply of material.

28. The system as claimed in claim 25 wherein the hardware interfaces, as which include electrical interfaces, are provided for transmission control for the data from the detected profile to the machines for the surface machining and for transmission control for the data from the detected profile for supply of material.

29. The system as claimed in claim 25 wherein a plurality of subsystems which are located, in particular, at different physically separate sites and which comprise at least one subsystem formed by a materials depot and a subsystem for production control.

30. The system as claimed in claim 29 wherein the subsystem for production control comprises at least one coordination system for reciprocal coordination of information signals and a plurality of communication systems with predominantly linear flow of information from one system element to the other.

31. The system as claimed in claim 30 wherein a communication system respectively has a system element for data conditioning and a hardware interface for transmission control for the data from the detected profile to the machines for the surface machining and for supply of material.

32. The system as claimed in claim 25 wherein the couplings and interactions between the system components are implemented using remote data transmission, supported by a computer, via the Internet (INET) or local area networks.

33. The system as claimed in claim 25 wherein a subsystem which contains an interface, which implements a link via the Internet or a local area network, for the purpose of data transfer, for transmitting data detected at a plurality of different locations from profiles, in a system element.

34. The system as claimed in claim 33 wherein the subsystem used for data transfer of the detected data from the profiles contains a server in a client/server arrangement, the data from the profiles being detected using the client.

35. The system as claimed in claim 33 wherein the subsystem used for data transfer of the detected data from the profiles as a further system element, a database storing the data detected at the different locations from profiles, in the form of wear data of the wheel possibly with a connection to km coverages and nominal and/or learning curves.

36. The system as claimed in claim 33 wherein the subsystem used for data transfer of the detected data from the profiles, contains a needs analysis system as a system element.

37. The system as claimed in claim 35 wherein the needs analysis system is in interaction firstly with the database and secondly with materials depot.

38. The system as claimed in claim 36 wherein the knowledge-based databases, are implemented in the needs analysis system.

39. The system as claimed in claim 38 wherein the databases implemented in the needs analysis system contain data obtained empirically through extrapolation or interpolation of measured values for the wear of the wheel or data which are based on a wear model which has been set up on the basis of theory.

40. The system as claimed in claim 25 wherein a digital signal processor, one arranged in the client, for determining a detection time (t_{flash}) at which the data from the profile are detected.

41. The system as claimed in claim 25 wherein a display integrated in a subsystem, in which data from the detected profile, nominal curves, from the wear, information relating to measurement locations or locations to be machined or result summaries from a comparison between the detected profile and a limit value or warning value are indicated in the form of graphical representations or verbal information.
